(19) United States
(12) Patent Application Publication
(10) Pub. No.: US 2006/0283076 A1
(43) Pub. Date: Dec. 21, 2006

(54) Insect trap

(75) Inventors: Derrell L. Chambers, Kensington, CA (US); Richard Alvarado, Fresno, CA (US); John D. Knapp, Fresno, CA (US)

Correspondence Address: KENNETH J. HOVET;NORDMAN, CORMANY, HAIR & COMPTON LLP, P.O. BOX 9100, 1000 TOWN CENTER DRIVE, OXNARD, CA, 93031-9100, US

(73) Assignee: Farma Tech International Corporation

(21) Appl. No.: 11/158,466

(22) Filed: Jun. 21, 2005

(51) Int. Cl. A01M 1/14

(52) U.S. Cl. 43/114

(57) ABSTRACT

An insect trap is provided that is constructed of a precut sheet of foldable material. The sheet includes vent slots and adhesive layers over selected solid exterior areas. One or more base score lines extend across the mid-portion of the sheet to divide the sheet into first and second side walls. A flap score line extends across the upper sheet width to define a flap section and lateral score lines extend along the longitudinal extent of the sheet inward from the sheet opposing lateral edges, to define end wall parts. The trap is assembled by folding inwardly the end wall parts and rotating together the first and second side walls about the base score lines. The side walls are held together by rotating the flap section about the flap score line and securing it to corresponding upper portions of the adhesive layers.

### BACKGROUND OF THE INVENTION

1. Field of Invention

The present invention relates to portable insect traps. In particular, the invention concerns disposable insect traps for outdoor use, utilizing an adhesive insect entrapment means on a disposable housing with an attractant lure.

2. Description of Related Art

Common problems with existing insect traps are that they are complicated and expensive to produce. As such, they are too costly to be disposable. Additionally, existing traps require multi-step assembly processes, even though they are initially formed from blank sheet materials.

For example, U.S. Pat. No. 6,516,558 describes an insect trap that includes an elaborate roof structure having a significant ridge construction produced from sheet materials. The ridge construction includes openings for insertion of roof-locking tabs. The roof is supported by end flaps having additional tabs which extend into base seam slots for additionally supporting the roof. The trap is too elaborate to be disposable, and would not be affordable for use in relation to large insect infestations.

U.S. Pat. Nos. 4,485,581 and 4,959,992 also describe insect traps constructed from blank sheet materials. However, they both require multiple folded panels to create interior chambers and unnecessary multi-layered grill panels.

U.S. Pat. No. 5,634,293 seeks to overcome the above insect trap structures with a two-part system. A support stand is provided with a center slot into which extends the crease of a bifolded adhesive sheet. The adhesive/attractant surfaces of the bifolded sheet face are layered outwardly against the face of the stand to attract insects. After use, the crease is pulled rearwardly from the slot, whereby the adhesive surfaces are drawn together to enclose and seal the insects between the surfaces. While this device may be suitable for use in a backyard or garden, it would not be suitable for high-volume agricultural use because of its limited attractant surface area and frequent need for replacement of the adhesive/attractant sheets.

### SUMMARY OF THE INVENTION

The abovementioned prior art problems are overcome with the insect trap of the present invention. It is constructed of an inexpensive creasable sheet material that is resistant to outdoor ambient conditions. The sheet material is provided with hinge means shown as predetermined score lines, which allow a user to fold the sheet along the score lines and form a housing having essentially two operating side walls with vent openings. The housing interior surfaces are non-sticky and the housing exterior surfaces are provided with an insect entrapment means, such as a sticky substance.

The interior space of the trap is provided with an insect attractant means, such as an attractant dispensing body comprising a thin wafer impregnated with an insect attractant formulation. Other types of attractant means could be used, such as attractant impregnated plugs, pastes, woven sheets or baskets that hold various lure formulations. However, an advantage of the trap is that it accommodates a thin self-supporting wafer without the aforementioned bulky plugs or baskets that require suspension means.

The trap includes a fold-over flap and a tear-strip that allows the trap to be folded upon itself after use. This action creates a trap enclosure in which the sticky surfaces face inwardly, so that the integrity of the insects captured thereon may be protected against damage during subsequent shipment and scientific evaluation.

The completed trap includes a connector means for engagement with an ambient structure. This allows the trap to be suspended from bushes, trees and other elevated structures which are located in areas of interest.

### BRIEF DESCRIPTION OF THE DRAWINGS

FIG. 1 is a front isometric view of the trap of the present invention.

FIG. 2 is a cross-sectional view taken along lines 2-2 of FIG. 1.

FIG. 3 is a plan view of the interior surfaces of a sheet preform, which is used to produce the trap shown in FIG. 1.

FIG. 4 is a cross-sectional view similar to FIG. 2 depicting a used trap being taken out of service by removal of a tear strip.

FIG. 5 is an elevational view of the trap of FIG. 4, with the tear strip removed and the sidewalls being rotated outwardly.

FIG. 6 is an elevational view of the trap of FIG. 5 with the sidewalls inverted and rotated about 180° against each other in preparation for transport.

### DESCRIPTION OF PREFERRED EMBODIMENTS

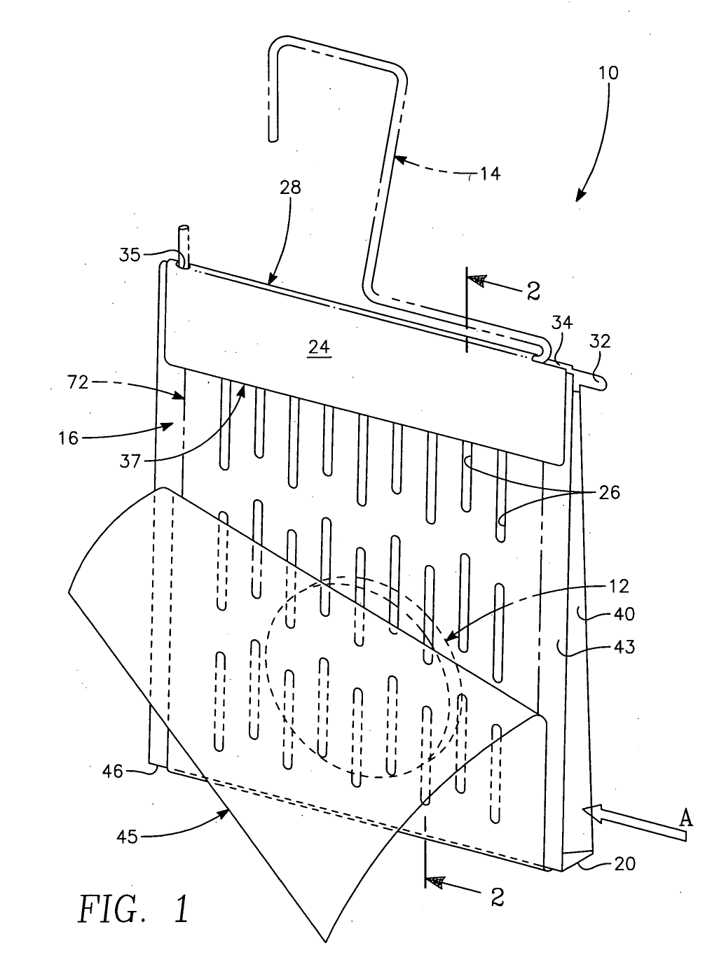

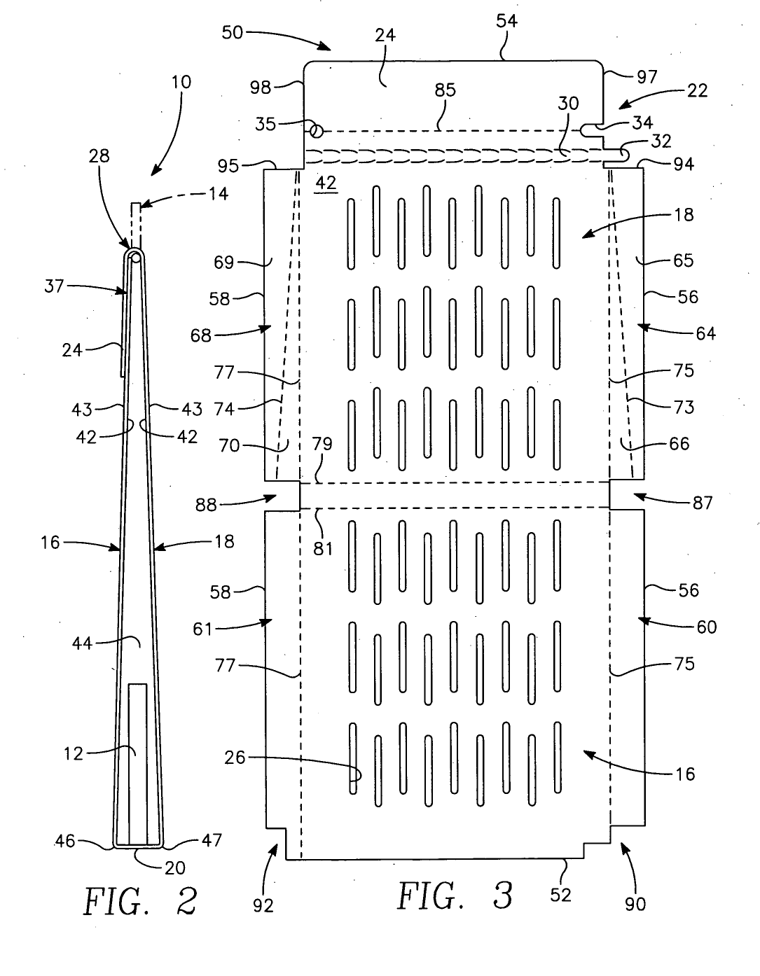

With particular attention to FIGS. 1 and 2, the overall insect trap is shown by reference 10. The trap comprises a housing having a first sidewall 16 and a second sidewall 18. The sidewalls extend upwardly from a base 20. The base includes hinge means that interconnect the sidewalls. As shown, the base comprises a base wall with a width defined by the space between front edge 46 and back edge 47. As discussed hereinafter, the front and back edges are defined by score lines which may also function as the aforesaid hinge means.

The first sidewall extends from front edge 46 a predetermined distance to a top edge 52. The second sidewall 18 extends from back edge 47 to a flap edge 54. At least the exterior surface 43 of first sidewall 16 is provided with an effective amount and distribution of insect adhesive 72. To maximize effectiveness, it is preferred that selected exterior surfaces of both sidewalls be provided with insect adhesive.

Both sidewalls include vertically aligned vent means shown as vent slots 26. Preferably, the vent slots 26 are aligned vertically in multiple spaced-apart rows to create unapertured aligned sidewall surface areas. With this arrangement, strips of adhesive 72 may be applied onto the solid surfaces in areas on either side and in-between each row of slots. Optionally, the adhesive may be coatings of adhesive material applied to selected areas of the exterior sidewall surfaces 43.

The use of slots provides for improved air flow and facilitates the application of adhesive, which is difficult with the random apertures of the prior art. Additionally, the slots may have unequal lengths and widths and may be vertically and horizontally offset at variable distances. The overall purpose is to effect the desired venting characteristics while taking into account the solid area needed for adhesive application and effectiveness.

The first sidewall 16 includes an upper region 37, which includes a flap securement means. Preferably, this means may comprise a defined layer of the insect adhesive 72. The adhesive permits the first and second sidewalls to be joined together by folding the flap section 24 over top edge 52 and against the adhesive on upper region 37. Other flap securement means could be used such as clips, snaps, pins, staples, Velcro fasteners and tapes.

Opposing end walls of the trap are enclosed with a respective first end wall 40 and an opposing second end wall 44. Each of the end walls are comprised of foldable respective first and second end wall parts which may slide adjacent each other during assembly in a manner to be hereinafter discussed.

Upon completion of the trap housing construction procedure, hanger 14 (shown in phantom) is engaged with the trap connector means. See FIG. 1. In particular, a lower portion of the hanger is inserted into hanger notch 34 and moved along the top crease area 28 of the flap section 24. Proximate the opposing end of the crease area is hanger opening 35. A terminal upturned end of the hanger lower portion projects up through the hanger opening to releasably secure the hanger to the trap. The upper portion of the hanger comprises a hook constructed to engage the aforementioned structural elements, such as tree branches, posts and other suitable supporting structures. The above-described hanger is commonly known as a Jackson Trap Wire Hanger.

Prior to engagement of the hanger to a support structure, a wafer 12, containing an insect attractant, is moved through an end wall area and into the housing interior area, as shown by arrow A in FIG. 1. The wafer will emanate vapors during exposure to ambient air. The vapors will flow out of the vent slots 26 and into the surrounding ambient air. Insects (I) in the vicinity of the surrounding air will investigate the source of the vapors and land on the adhesive coating 72 of the sidewalls. The adhesive will have effective adherent characteristics such that when landed upon by an insect, the adhesive will not permit the insect to become disengaged.

After a period of time wherein all the attractant volatile material has been diffused, or when the trap has otherwise become filled, or the adhesive has lost its adhesive properties and/or after the trap starts becoming weather worn and begins, losing its structural integrity, an operator can unhook the trap from its hanging site and dispose of the trap.

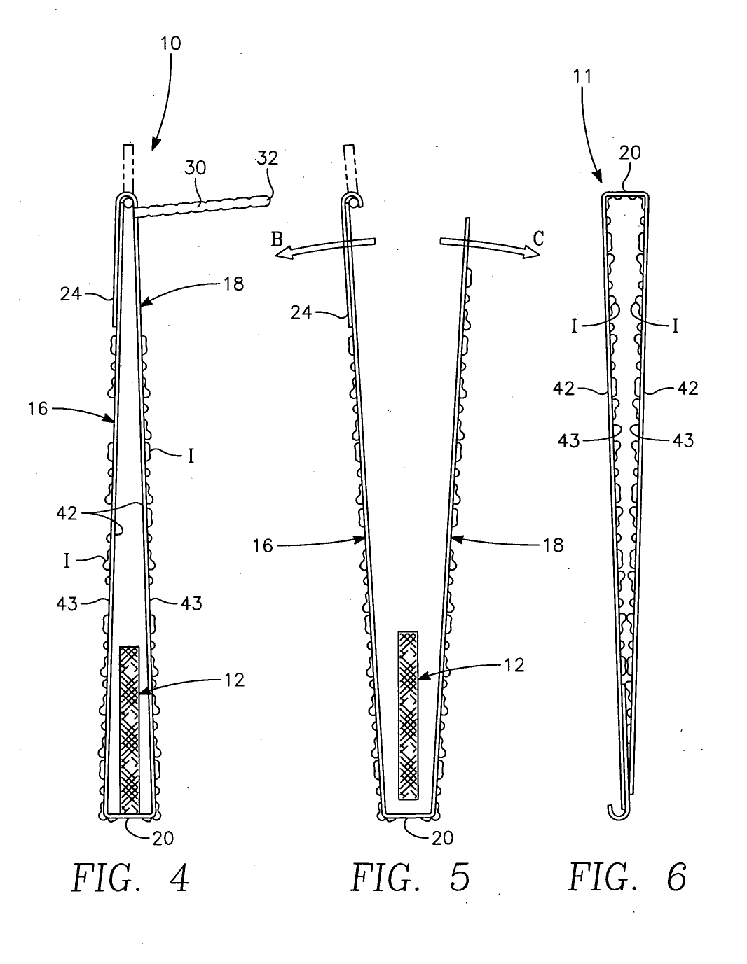

With reference to FIGS. 4-6, if the trapped insects (I) are to be transported to a test facility for evaluation, then the trap housing can be opened with a wall separation means shown as tear strip 30. The tear strip extends across the width of upper portion 22. In operation, a user may grasp tear tab 32 at an end of the tear strip 30, and remove the tear strip from the upper second wall portion 22 of the second sidewall 18. This will result in disengagement of the second wall 16, and allow each sidewall to be rotated about 180° around respective base front edge 46 and base back edge 47, into a transport position.

The above movement, depicted by arrows B and C in FIG. 5, forms a new housing-like enclosure 11 as shown in FIG. 6. The sidewall surfaces are now reversed, whereby the former sidewall inner surfaces 42 become outer surfaces, and wherein the insect-containing outer surfaces 43 are facing inward. In this orientation, the sidewalls may be secured together and the used trap containing the insects may be discarded or transported to a laboratory for scientific evaluation.

A feature of the invention is the convenient manner for constructing the insect trap 10 with the use of a preformed sheet of creasable material. Such material may comprise a thin plastic sheet, or multi-sheet laminate, or a liquid-resistant packaging grade paperboard stock material. Preferably, the stock material will have a weather-resistant poly coating on both surfaces, so that the resultant trap will be capable of withstanding outdoor service for several weeks.

Initially, a selected sheet of material will be cut into an outline with vent openings as described below and shown in FIG. 3. Thereafter, the cut sheet is provided with score lines that primarily determine the structure of the first and second end walls 40, 44 and flap section 24.

The overall outline of the sheet 50 comprises first lateral edge 56, and opposing second lateral edge 58. Both edges are spaced-apart a predetermined distance, and extend parallel to each other. The first lateral edge 56 extends from stepped corner 90, which forms an offset from top edge 52 of the sheet. The first lateral edge extends to a mid area first cut-out 87, which has a width that corresponds to the spacing between the front base score line 81 and back base score line 79. The lateral edge 56 continues from the first cut-out 87 to a first wall shoulder 94, where it extends inwardly and merges with tear tab 32 in the upper second wall portion 22.

Second lateral edge 58 extends from recessed corner 92 formed in top edge 52 of the sheet, and extends to a second cut-out 88 having a shape and dimensions about identical to first cut-out 87. The second lateral edge 58 continues to second wall shoulder 95, which extends upwardly to a second flap side edge 98. The opposing flap side edges 97, 98 extend outwardly in a direction parallel to respective first and second lateral edges 56, 58, and then merge into the aforementioned flap edge 54.

Extending across the width of the lower area of flap section 24, is flap score line 85. The score line continues from hanger notch 34, and extends through hanger opening 35 to the aforementioned second flap side edge 98. It will be appreciated that the distance from the flap score line 85 to back base score line 79 is about equal to the distance from front base score line 81 to the sheet top edge 52. When the sheet is folded along the front and back base score lines, top edge 52 will be about coextensive with the aforementioned flap score line 85. The flap score line 85 also functions to form an uppermost crease area 28 when the flap is folded over against the first sidewall upper region 37.

It will be appreciated that although the base 20 is shown as having a predetermined width defined by the spacing between the front and back base score lines 79,81, only a single score line could be used. In such case, the first and second cut-outs 87, 88 would be eliminated.

As mentioned above, the first end wall 40 and second end wall 44 comprise co-acting end wall parts formed between predetermined first and second lateral score lines and respective first and second lateral edges 56, 58. For purposes of explanation, it will be assumed that FIG. 3 is a plan view of the non-sticky interior face 42 of sheet 50, with the sheet back side being a mirror image thereof. In such case, the polygonal wall parts will be folded upwardly and inwardly toward each other during the insect trap assembly process.

The second sidewall 18 includes first angular wall part 64, which is defined by the area between first lateral edge 56 and first lateral score line 75. The first angular wall part 64 includes a first diagonal score line 73 that extends from first cut-out 87 and angles inwardly toward the closed end of first wall shoulder 94. The first diagonal score line thereby forms an additional fold area to produce a first outer tapered portion 65 and a first inner triangular portion 66 of the overall angular wall part 64.

When the first angular wall part 64 is folded along the above-described score lines, the overall result will be a tapered first end wall 40, beginning with the widest part at back base score line 79 and narrowing to an apex at first wall shoulder 94.

In a similar manner, the opposing second angular wall part 68 includes second diagonal score line 74, in addition to second lateral score line 77. When the second angular wall part 68 is folded along the above score lines, a second outer tapered portion 69 and a second inner triangular portion 70 are formed, thereby providing for an overall tapered second end wall 44.

As shown in FIG. 3, the first and second lateral score lines 75, 77 also extend in a straight and parallel manner through the side margins of first sidewall 16 from front base score line 81 to top edge 52. The score lines define respective margin areas which, when folded upwardly and inwardly, create respective first polygonal wall part 60 and second polygonal wall part 61.

Upon completing the above-described end part folding actions, the first and second sidewalls 16, 18 are rotated together about respective back and front base score lines 79,81 until top edge 52 is coextensive with first and second wall shoulders 94, 95. During this movement, the first and second polygonal wall parts 60,61 and the first and second angular wall parts 64, 68 are maintained in an inwardly folded disposition.

To ensure that the first and second end walls 40, 44 provide a tapered configuration for the trap housing as generally defined by the shape of first and second angular wall parts 64, 68, the first and second polygonal wall parts 60, 61 should be maintained in a position closely adjacent corresponding interior wall surfaces 42. Therefore, upon release of each of the folded end wall parts and upon completion of the sidewall rotation, the polygonal wall parts 60, 61 will be inclined and adjacent to respective first and second outer tapered portions 65, 69. This juxtaposition of parts will allow the first and second inner triangular portions 66, 70 to be the primary determinant for the tapered configuration of first and second end walls 40, 44.

After the first and second sidewalls 16, 18 are brought together, optional hanger 14 may be positioned so that its lower portion is in engagement with hanger notch 34 and hanger opening 35. Thereafter, adhesive cover sheet 45 may be at least partially drawn away from the first wall upper region 37 to expose a predetermined corresponding upper adhesive area. Then, flap section 24 may be rotated about flap score line 85 and into contact with the upper adhesive. This action secures the sidewalls together and completes the assembly process of the trap housing.

Prior to placing the trap into service, an operator may locate an insect attractant within the housing interior. If the attractant comprises a thick paste, this may be most conveniently smeared onto the interior wall surfaces 42 before securing together the sidewalls 16, 18. In the embodiment shown, the attractant is in the form of a wafer 12. Because the wafer has structural integrity and the respective end wall parts are not fixed together, the wafer can be moved against an end wall, as shown by Arrow A, and deflect the corresponding scored wall parts to permit passage of the wafer into the trap interior.

Subsequently, adhesive cover sheet 45 is entirely removed from the adhesive coated areas of exterior wall surfaces 43. The trap may now be placed in service by suspending the trap from a selected support structure with hanger 14.

Upon completion of the trap service period, the trap may be converted from its housing structure position to a collapsed transport position. As described previously with reference to FIGS. 4-6, the conversion occurs when the operator removes tear strip 30. Then, the sidewalls are rotated backwards around the base score lines to reverse the wall surface exposures so that the exterior surfaces 43 become inner surfaces containing retained insects (I). The interior surfaces 42 will simultaneously become outer surfaces which contain no adhesive. The absence of outer sticky surfaces permits easy handling, storage and shipment of the used trap.

From the above, it can be seen that the invention provides a trap that is inexpensive and requires no mechanical parts other than a nail, hook, rope, wire or hanger to suspend the trap from an ambient support structure. The sheet can be readily die-cut from stock materials, and be provided with predetermined score lines that allow an operator to manually create the trap housing by simple folding steps. Moreover, when the trap is used for testing or other scientific purposes, the integrity of the trapped insects are protected simply by inverting the trap sidewalls, which is permitted through the use of an integrated tear strip.

Many variations of the foregoing description comprising equivalent structures and processes will be readily apparent to those skilled in the art as falling within the spirit and scope of the claimed invention. Accordingly, the appended claims are to be interpreted according to the widest scope of meaning.

We claim:

1. An insect trap comprising:
a housing having an insect attractant and an insect entrapment means for engaging an insect;
said housing comprising a base from which extends respective upstanding first and second sidewalls, with at least one sidewall having a vent means for providing air passage through the sidewall, said vent means comprising openings which are spaced-apart in a manner to provide unapertured aligned sidewall surface areas;
said first sidewall having a defined first height that terminates at a first top edge;
said second sidewall having a second height that is greater than said first height, with the difference between the first and second heights comprising an upper wall portion; and,
said upper wall portion having an outer flap section that is foldable over an upper region of said first sidewall.

2. The insect trap of claim 1 wherein said flap section is attached to said upper region.

3. The insect trap of claim 2 wherein said upper wall portion includes a separation means for disengaging said flap section from said upper wall portion.

4. The insect trap of claim 2 wherein said insect entrapment means comprises an adhesive overlying an effective portion of at least one of said side walls and at least said upper region, said flap section being attached to said adhesive.

5. The insect trap of claim 1 wherein said first and second sidewalls have respective interior and exterior surfaces, said insect trap means comprising an adhesive over at least a portion of said exterior surfaces.

6. The insect trap of claim 5 wherein said first and second sidewalls are connected to said base by hinge means, so that said first and second sidewalls can be rotated from a housing structure position to a collapsed transport position, whereby said interior surfaces become outer surfaces and said exterior surfaces become inner surfaces.

7. The insect trap of claim 1 wherein said housing has opposing first and second end walls and said first sidewall has opposing first end wall parts that form at least a respective part of said first and second end walls.

8. The insect trap of claim 7 wherein said second sidewall has opposing second end wall parts that form at least a respective part of said first and second end walls.

9. The insect trap of claim 8 wherein said second end wall parts have an angular configuration.

10. The insect trap of claim 9 wherein said second wall parts comprise respective first and second outer tapered portions and respective first and second inner triangular portions.

11. An insect trap comprising:
a sheet folded into the shape of a defined insect trap, said sheet having an overall periphery generally defined by a top edge and an opposing flap edge which merge with respective opposing lateral edges;
each lateral edge having a respective lateral score line located inwardly from each corresponding lateral edge, each lateral score line extending about parallel to each respective lateral edge to define a respective overlapping end wall part of said trap when folded in a predetermined manner along each lateral score line;
said sheet including a flap score line offset inwardly from the flap edge and about parallel to said top edge;
said sheet having at least one base score line extending between a lateral score line about parallel to said top edge and proximate the mid-point of said sheet; and,
said base score line defining a first sidewall between the top edge and base score line, and a second sidewall between the flap score line and the base score line, said first and second sidewalls being folded against each other about said base line to form said trap.

12. The trap of claim 11 including a second base score line spaced-apart from said one base score line a predetermined distance to define a base wall when said first sidewall is folded about said one base score line and said second sidewall is folded about said second base score line.

13. The trap of claim 11 wherein each end wall corresponding to the lateral score line of said second wall includes a diagonal score line to provide a triangularly-shaped end wall when said sheet is folded in a predetermined manner along both of the corresponding lateral fold line and the diagonal score line.

14. The trap of claim 11 wherein the area between said flap score line and the flap edge defines a flap structure that may be folded over said top edge and attached to an upper region of said first sidewall.

15. The trap of claim 14 wherein said second sidewall includes tear lines extending across at least a portion of the second sidewall at a distance from said flap edge that is greater than the distance said flap score line is from said flap edge.

16. A method constructing an insect trap comprising:
a) providing a sheet of foldable material having a width defined by the space between opposing lateral edges and a length defined by the distance between a flap edge and an opposing top edge;
b) providing a base score line across said width about half way between said flap edge and said top edge, said base score line subdividing said length into a first side wall and a second side wall;
c) providing a flap score line across said width a predetermined distance below said flap edge to define a flap section;
d) moving said top edge adjacent said flap score line;
e) folding said flap section about said flap score line and over said top edge; and,
f) securing said flap section to an upper region of said second side wall.

17. The method of claim 16 including the steps of:
g) providing a lateral score line inward of each lateral edge a predetermined distance to define respective end wall parts; and,
h) after step c), folding said end wall parts inwardly to form end walls of said insect trap.

18. The method of claim 16 including the step of:
i) after step e), attaching an ambient structure connector means having a lower portion to said insect trap by positioning said lower portion adjacent said flap score line so that during step e), the lower portion will be enclosed by said flap section.

19. The method of claim 16 wherein step d) is carried-out by rotating said first and second side walls toward each other about said base score line.

20. The method of claim 16 wherein said upper region includes an adhesive and step f) is carried-out by moving said flap section against said adhesive.
